(19) United States
(12) Patent Application Publication
(10) Pub. No.: US 2008/0217111 A1
(43) Pub. Date: Sep. 11, 2008

(54) Support Leg Turck

(76) Inventors: Magnus Carlsson, Vikingstad (SE); Fredrik Larsson, Mjolby (SE)

Correspondence Address: HAYES SOLOWAY P.C., 3450 E. SUNRISE DRIVE, SUITE 140, TUCSON, AZ, 85718, US

(21) Appl. No.: 11/569,245

(22) PCT Filed: May 18, 2005
(86) PCT No.: PCT/SE05/00731

§ 371 Date: Dec. 26, 2006

(30) Foreign Application Priority Data
May 19, 2004 (SE) 0401297-7

(51) Int. Cl. B66F 9/12; B66F 9/075

(52) U.S. Cl. 187/237

(57) ABSTRACT

Support leg truck with wheels or rollers in the front edges of the support legs and in the rear end, with a drive wheel on one side and a pivot wheel on the other side, one support leg being more strongly dimensioned than the other one so that when load is subjected the greatest force is taken by the more strongly dimensioned support leg. Advantageously the stronger support leg is arranged diagonally in relation to the drive wheel.

This invention is related to fork trucks with four wheels and of the type support leg truck. Support leg trucks have two forwards extending legs. The support legs are horizontal and have a small height and are placed below the lifting forks of the truck and are in their outer (front) ends provided with rollers. The lifting forks are fastened in a lifting carriage that in a vertical guide can be lifted up from the support legs. The support legs are in their rear ends fastened to a drive section that includes motor, batteries, and lifting hydraulics and support on the front side said vertical guide, lifting carriage and forks. Furthermore in the case of a four-wheel support leg truck a driving wheel that is also steerable is arranged in one rear corner of the drive unit. In the other rear corner a support wheel is arranged in the shape of a freely pivotable pivot wheel that adjust itself as a result of the movement of the truck. Since the truck has four wheels it is comparatively steady and since only one wheel is driven and steered the construction is economically advantageous and furthermore allows the use of a steered wheel that can be turned around an arbitrary number of revolutions, which in turn allow quick manoeuvering.

A problem at these trucks is however the securing of sufficient drive wheel pressure against the ground, which always must be large enough to allow the propelling of the truck and perhaps even more important braking. Since the drive wheel is both steered and driven the available friction forces are made use of far more than for the other wheels and therefor also the wear of this wheel will be the greatest. This in turn means that when the wear increase the contact pressure of the drive wheel is reduced finally to become too small to allow steering, driving and braking. When the wheel every now and then slip the wear increase further. To remedy this it is known to use more or less sophisticated link-systems to ensure the contact of the drive wheel with the ground. This is however costly due to the many parts and also require careful adjustment, and service since these parts will wear.

Another way to ensure a satisfactory contact pressure of the drive wheel is to locate the rear, freely pivotable support wheel somewhat higher than the drive wheel. Alternatively one can place the drive wheel displaced somewhat towards the center of the truck to increase the pressure on this. These measures however have the drawback that the stability of the truck is reduced. Furthermore the truck will be somewhat inclined and sometimes the truck may wobble between lifted and contact positions of the support wheel, both phenomena being unpleasant for the driver.

In view of the above problems there exist a need for a simple efficient and low-cost solution of how one at four wheel trucks ensure that the drive wheel always has sufficient contact pressure against the ground.

In order to remedy the above problems it is in accordance with the invention suggested that the support legs are made different in such a way that the required force for the same deflection upwards of the outer ends of the support legs will be different for the two support legs. In other words at the same deflection upwards of the outer ends of the support legs the contact forces against the ground for the rollers of the support legs will be different. The ability or tendency to take forces in vertical direction of the front wheel or roller provided support leg ends thus become different.

For instance the support legs may be made differently strong, differently sturdy or with different rigidness against bending.

The result of the above arrangement is that the truck always exert more force on the front wheel that is carried by the stronger or against bending stiffer support leg, this in turn means that the drive wheel will always be a part of a triangle with three powerful supporting wheels and one can therefor be certain of a satisfactory large contact pressure for the drive wheel.

Advantageously the weaker support leg is arranged on the same side as the drive wheel so that the truck receives its major support from two diagonally arranged wheels.

The weaker support leg is advantageously made weaker or less rigid against bending than the other by a reduction of its height, since in this way its resistance against strain and movements in other directions than up and down essentially may remain. One can however also consider that the width or cross section areas of the support legs are made different.

Since the two support legs together must support a great part of the load the weakening of one support leg means that the other one is made correspondingly stronger, so that the total force taking ability is sufficiently large.

As an alternative to making the support legs differently strong one can consider to mount the support legs with slightly different angles in relation to the horizontal plane of the truck. One can also consider to bend one support leg in its vertical plane of symmetry in order to achieve the difference in contact pressure.

The difference in yieldingness need not necessarily be achieved only in the support legs, but one can also consider the difference in stiffness extending further rearward in the truck, for instance even to a drivers platform arranged between batteries and forks. For instance the side beams on one side of the truck may be dimensioned weaker than on the other side. One can also consider the difference in yieldingness being achieved in connection with the fastening of the support legs in the frame of the truck.

An essential advantage with the invented device is that the truck during normal circumstances always will have all four wheels in contact with the ground and therefor always feels stable which is not always the case with the known solutions.

Instead of giving the weaker support leg a lower height one can consider to provide this with other weakenings, for instance in the form of recesses on the bottom side, or even hollow in case one want to retain a symmetric look for the support legs. To the same result also different materials can be used in the two support legs.

Advantageously the weaker support leg is dimensioned 20 to 50% weaker than the stronger support leg.

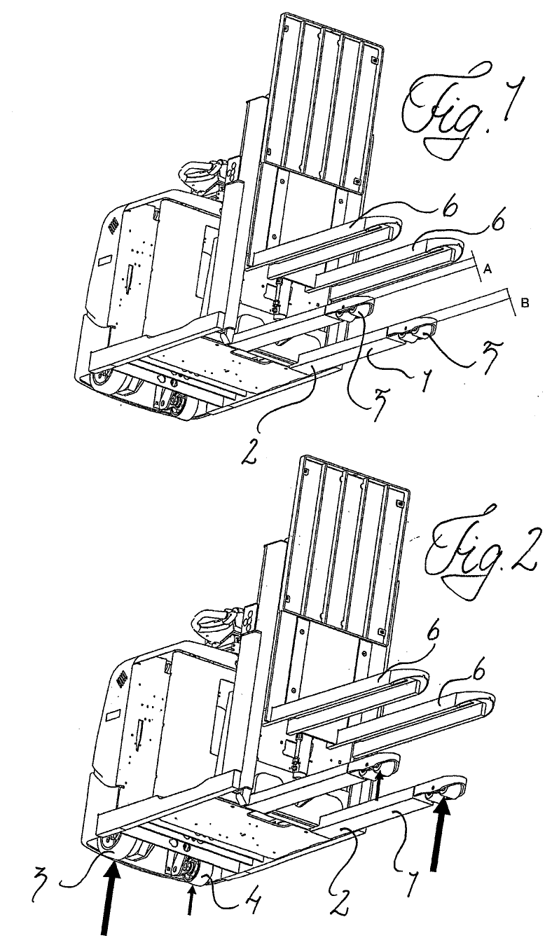

Further advantages and characteristics of the invention are apparent from the following description of an embodiment shown in two figures on the enclosed drawing. Both figures show a truck in perspective seen obliquely from below. In FIG. 1 the dimensioning of the truck is shown and in FIG. 2 the force distribution of the wheels is depicted.

The truck shown on the drawing is in its entirety referenced with 1. Two support legs 1 and 2 extend forward fastened to the frame of the truck by welding or bolts. In the rear end the truck is provided with a drive and steered wheel 3 on one side and a pivot wheel 4 at a position in the rear end of the truck placed symmetrically in relation to the drive wheel. Above the support legs load forks 6 are located and above the rear wheels in particular the heavy batteries of the truck are placed. The support leg 1 is stronger than the support leg 2 due to the thickness/height B of the support leg 1 being greater than the thickness A of the support leg 2. Since the support leg 2 is more yielding the good contact against the ground for the drive/steered wheel is ensured, which is illustrated with the force arrows directed towards the wheels shown in FIG. 2.

When the truck is empty the center of gravity due to the weight of the batteries will be located far to the rear and the forces are essentially taken up by the roller of the stronger support leg in the front end and by the drive wheel and the support wheel in the rear end.

If the truck is loaded with a great load on the forks the center of gravity can be displaced forward a sufficient amount to place it in front of the diagonal between the driving wheel and the roller in the stronger support leg. In this case the weaker support leg will yield somewhat so that the weight mainly is taken by the front support rollers below the support legs and by the drive wheel.

Since the drive section has to be made very strong it can without real extra costs be made sufficiently torsionally stiff, preferably in combination with rigid tire tread for the wheels, to ensure that the drive section remain horizontal and that no slip occurs for the drive wheel, which reduce the wear.

Independent of the location of the load the drive wheel will always be located in one corner of a force transfer triangle with wheels or rollers in the corner points and is thus always subjected to a sufficient force to enable good tractive and braking force as well as good steerability.

As is realized the invented device is particularly simple to implement and also the mounting is facilitated since the support legs can be mounted symmetrically and in particular in the same plane despite the asymmetric force transfer.

1-7. (canceled)

8. A support leg truck having one or several support wheels or rollers in front ends of the support legs and two rear wheels of which one is drivable and steerable while the other is a pivot wheel, wherein the support legs have differing yielding or bending upwards characteristics when subjected to a force acting in a vertical direction on the front ends of the support legs.

9. The support leg truck according to claim 1, wherein the support legs have different bending resistance in a vertical direction.

10. The support leg truck according to claim 2, wherein a support leg with greater bending resistance is arranged diagonally in relation to the drive and steer wheel.

11. The support leg truck according to claim 1, wherein a difference in yielding is achieved by making the support legs with different heights or widths.

12. The support leg truck according to claim 1, wherein the difference in yielding is achieved by mounting the support legs at different angles in relation to a horizontal plane.

13. The support leg truck according to claim 1, wherein the difference in yielding is achieved by the support legs having somewhat different curvatures in a vertical direction.

14. The support leg truck according to claim 1, wherein the support legs are dimensioned such that load transfer is 20 to 60% less for the more yielding support leg.
